(19) United States
(12) Patent Application Publication
(10) Pub. No.: US 2012/0086246 A1
(43) Pub. Date: Apr. 12, 2012

(54) Twin-pad bicycle seat for long distance cycling

(76) Inventor: Armand Belliveau, Shediac (CA)

(21) Appl. No.: 12/923,768

(22) Filed: Oct. 7, 2010

(51) Int. Cl. B62J 1/00

(52) U.S. Cl. 297/201

(57) ABSTRACT

The bicycle seat has a pair of seat pads that are independently movably mounted side by side on a pivot axis. Each of the seat pads has a posterior support region and a thigh support region. The posterior support region has a longitudinal circular curvature with radii of curvature having origins located ahead of the pivot axis. The thigh support region is located ahead of the posterior support region and the pivot axis, and it is contiguous with the posterior support region. The thigh support region has a longitudinal parabolic curvature with a principal axis extending above the pivot axis. As a result, a movement of the seat in use is small and cosine-dominant in the posterior support region and is large and sine-dominant in the thigh support region.

### FIELD OF THE INVENTION

This invention pertains to bicycle seats having right and left seat pads, and more particularly, it pertains to a twin-pad bicycle seat that is constructed to withdraw from the thigh muscles upon tightening of the thigh muscles.

### BACKGROUND OF THE INVENTION

Several twin-pad-type bicycle saddles have been developed in the past to alleviate discomfort associated with long journeys on bicycles. Some of these twin-pad bicycle seats are illustrated and described in the following documents found in the prior art.
U.S. Pat. No. 606,818 issued to W. J. Best on Jul. 5, 1898;
U.S. Pat. No. 619,768 issued to R. Lewis, Jr. on Feb. 21, 1899;
U.S. Pat. No. 656,854 issued to J. Nord on Aug. 28, 1900;
U.S. Pat. No. 4,387,925 issued to J. A. Barker et al. on Jun. 14, 1983;
U.S. Pat. No. 5,387,025 issued to R. A. Denisar on Feb. 7, 1995;
U.S. Pat. No. 5,823,618 issued to H. M. Fox et al. on Oct. 20, 1998;
U.S. Pat. No. 5,988,740 issued to A. Caraballo on Nov. 23, 1999;
U.S. Pat. No. 6,402,235 issued to R. B. Letendre on Jun. 11, 2002;
U.S. Pat. No. 6,761,400 issued to R. Hobson on Jul. 13, 2004;
U.S. Pat. No. 6,786,542 issued to J. Nuzzarello on Sep. 7, 2004;
CA Patent 1,230,041 issued to A. Swarbrick on Dec. 8, 1987;
CA Patent Appl. 2,266,240 filed by P. G. Ney et al., publ. Sep. 10, 2000;
CA Patent 2,321,080 issued to R. J. Bavaresco on Apr. 26, 2005;
CA Patent 2,339,754 issued to J. F. Unger Jr. on Jul. 17, 2007;
CA Patent 2,350,813 issued to J. Dixon on Dec. 18, 2007;
CA Patent Appl. 2,557,715 filed by M. Jansch, publ. Sep. 15, 2005.

A number of twin-pad bicycle seats are also illustrated on the Internet at the time of writing the present document. These publications have been found at the following website addresses:

http://www.spiderflex.com
http://www.spongywonder.com
http://bicycleuniverse.info/eqp/seats
http://www.tesco-shopping.com/bikeseat.htm
http://www.hobsonseats.com
http://www.bikeco.co.uk

Long distance cycling requires endurance to muscular strain and fatigue. During training, most cyclists also develop endurance to pain. Ignoring pain can sometimes lead to permanent damage to one's body. The adverse consequences of ignoring pain in the posterior region of one's body are serious. These consequences are probably best explained in Hobson's U.S. Pat. No. 6,761,400, wherein the inventor states that a pointed-type bicycle seat can cause permanent damage to the penile artery in males and damage to reproductive organs of females. Ideally, a bicycle seat should have no pressure point and should allow unobstructed movement of the user's legs.

One advantage of the pointed-type bicycle seat is that it does not apply a pressure under the thigh muscles, thereby allowing these muscles to tighten and expand freely. As a contrast, twin-pad seats lie under the thigh muscles and cause pressure points under the thigh muscles, generally. Although several attempts have been made in the past to alleviate this problem, it is believed that a better seat is still needed.

### SUMMARY OF THE INVENTION

In the present invention, there is provided a new and improved twin-pad bicycle seat wherein the seat pads are constructed to withdraw from the thigh muscles upon tightening of the thigh muscles, for preventing the presence of any pressure point against the thigh muscles and for facilitating the movement of the thighbone during pedalling.

The present inventor has tested the twin-pad seat according to the present invention during a trip of 6,400 kilometres (3977 miles) across Canada. He found a noticeable improvement in his seat over all other twin-pad seats available commercially. The seat has allowed him to pedal over 200 km (124 miles) per day without difficulty.

In one aspect of the present invention, there is provided a twin-pad bicycle seat comprising a pair of seat pads that are independently movably mounted side by side on a pivot axis. Each seat pad has a posterior support region and a thigh support region. The posterior support region has a longitudinal circular curvature with radii of curvature having origins located ahead of the pivot axis. The thigh support region is located ahead of the posterior support region and the pivot axis. The thigh support region is contiguous with the posterior support region and has a longitudinal parabolic curvature with a principal axis extending above the pivot axis.

The bicycle seat according to the present invention is advantageous because a displacement of the posterior support region in use is small and cosine-dominant, and a displacement of the thigh support region in a same angular movement of the seat pad is large and sine-dominant. As a result, a movement of the seat pad in the posterior support region is almost imperceptible, while the thigh supporting region withdraws from the thigh muscles to allow the thigh muscles to tighten and swell under the effort of pedalling. Furthermore no part of the seat raises during a forward inclination of the seat.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 represents a perspective front, top and side view of a twin-pad bicycle seat according to the preferred embodiment of the present invention;

FIG. 2 represents a front view of the preferred seat;

FIG. 3 represents a rear view of the preferred seat;

FIG. 4 is a top view of the preferred seat;

FIG. 5 is a side view of the preferred seat in a normal position;

FIG. 6 is a side view of the preferred seat in a raised position;

FIG. 7 is a side view of the preferred seat with a compressed position shown in shadow lines;

FIG. 8 is an outline of the seat surface in relation to the pivot axis in the preferred seat.

### DESCRIPTION OF THE PREFERRED EMBODIMENT

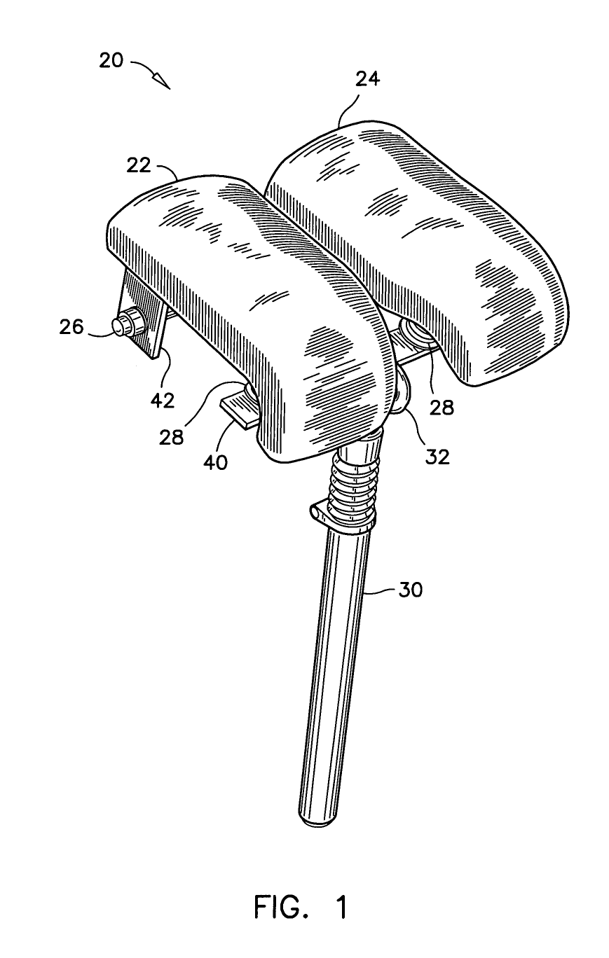

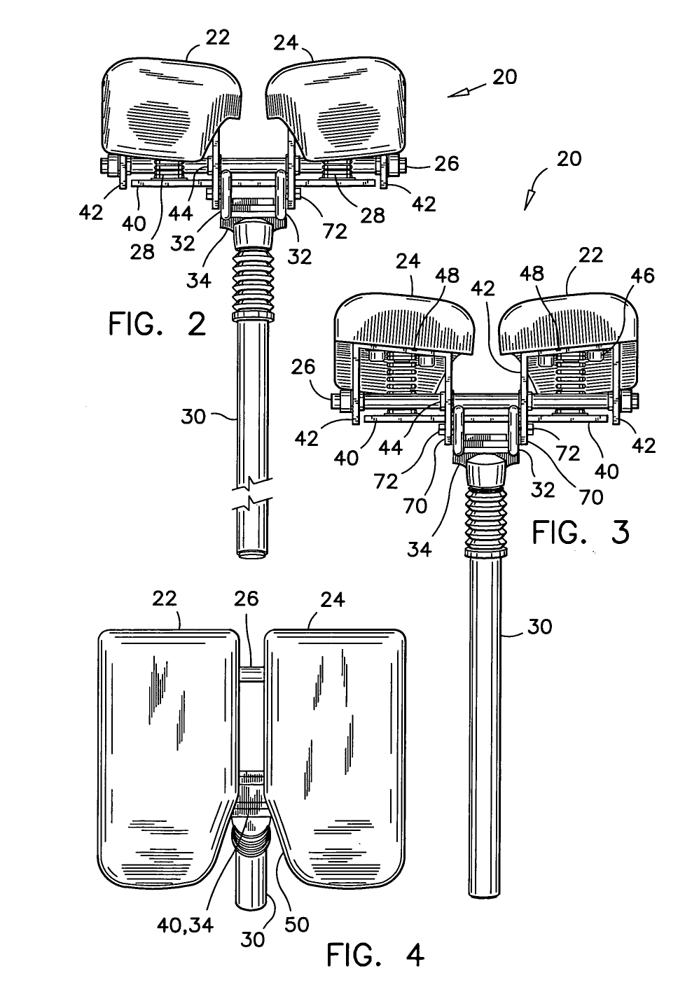

Referring firstly to FIGS. 1 to 4, the preferred twin-pad seat 20 has right and left seat pads 22, 24 mounted on a shaft 26 extending across the rear portion thereof. The shaft 26 is also referred to herein as the pivot axis 26. Springs 28 which are only partly illustrated in these drawings support the front portion of each seat pad 22, 24.

The twin-pad seat 20 is shown as mounted on a common seat post 30. This seat post 30 is illustrated for facilitating the understanding of the mounting and orientation of the seat 20 and is not part of the present invention.

The preferred twin-pad seat 20 is built on a pair of spaced-apart seat mounting loops 32 which are also common in bicycle seats. A common seat clamp 34 is used to fasten the pair of mounting loops 32 to the seat post 30.

The shaft 26 is affixed to the mounting loops 32 by welding for example, at the rear ends of the mounting loops 32. Both springs 28 are affixed to the seat pads 22, 24 at their upper ends and are supported to a flat bar 40 extending across the mounting loops 32 at the front ends of the mounting loops 32.

The seat pads 22, 24 are supported on the pivot axis 26 by a respective support bracket 42 and bushings 44. The bushings 44 are made of low friction material and they constitute bearings to allow the brackets 42 to rotate freely about the pivot axis 26. Each seat pad 22, 24 is affixed to a respective support bracket 42 by cap screws 46 or similar fasteners. Each support bracket 42 has an inverted U-shape and a top transverse segment 48 that is preferably inclined transversely downward toward the center of the seat as illustrated in FIG. 3. A preferred inclination of the top transverse segment 48 is about ¼ inch over the width of each seat pad. It has been found that this inclination improves the stabilizing properties of the seat 20.

As it may be understood from the illustration in FIG. 4, each seat pad has a chamfer 50 on the inside front corner thereof. These chamfers 50 are provided to create an open space between the forward ends of the seat pads to reduce the risks of applying a pressure against sexual organs of the user.

The seat pads 22, 24 may also be adjusted laterally relative to each other along the shaft 26 to satisfy preferences of a user for example.

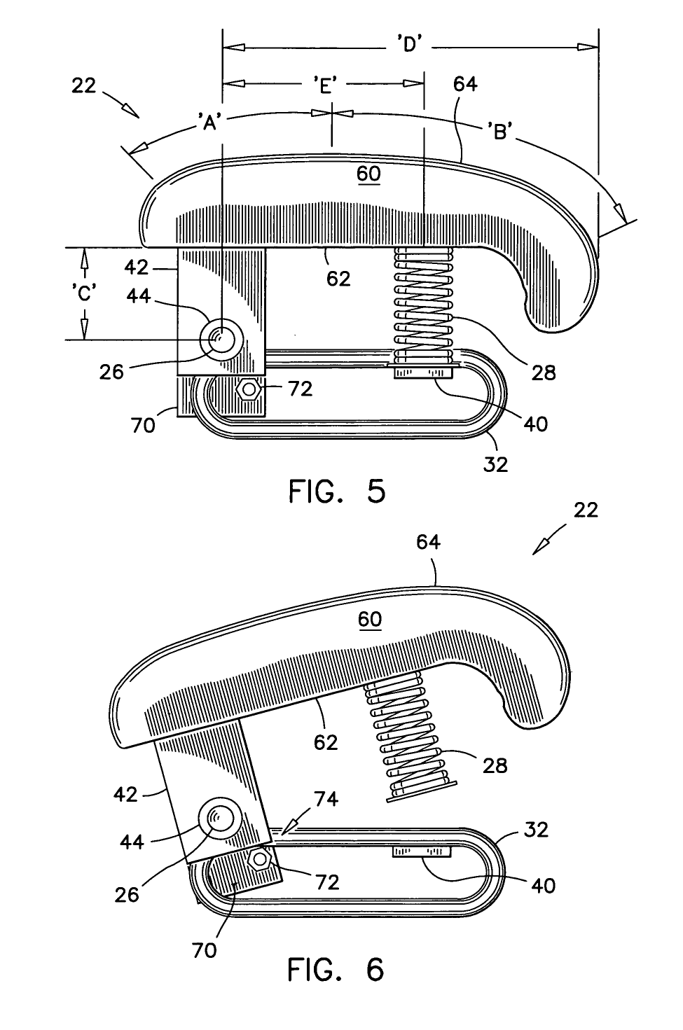

Referring now to FIGS. 5 and 6, each seat pad has a cushioned top portion 60 and a rigid base portion 62. The cushioned top portion 60 is made of a soft material such as upholstery foam and it is covered by a sheet of leather or a synthetic fabric material. The preferred hardness of the cushioned top portion 60 is no softer than common bicycle seats.

Although the following description emphasizes on one seat pad, pad 22 for example, it will be appreciated that the other seat pad 24 is a mirror image and it has the same elements.

The top portion 60 of each seat pad has a complex curvature 64 which comprises a longitudinal circular curvature along a posterior support region ‘A’, immediately above the pivot axis 26 and a longitudinal parabolic curvature along a thigh support region ‘B’.

The base portion 62 of each seat pad 22 is a rigid plate on which the top cushioned portion 60 is mounted and to which the support bracket 42 and the spring 28 are attached.

The pivot axis 26 is located at a distance ‘C’ of at least 25% of the total length ‘D’ of the seat pad on the forward side of the pivot axis 26. A preferred distance ‘C’ is about at least 1.8 inches measured on the outside leg of the support bracket 42. Another preferred dimension is the diameter of the shaft 26 of about 7/16 inch. Yet another preferred dimension is the distance ‘E’ between the spring 28 and the pivot axis 26. This distance is at least twice as much as the distance ‘C’ but this is not critical.

The support bracket 42 has a longer leg member 70 near the center, or inside, of the preferred seat 20. A bolt or a pin 72 extends across a lower portion of this longer leg member 70. Referring particularly to FIG. 6, this bolt 72 is located to interfere with the top cord of the mounting loop 32 at point 74 for example, when the seat pad 22 is tilted backward. The purpose of this bolt 72 is to limit the backward movement of the seat pad 22 when a cyclist changes position from sitting to standing. The blocking of the upward movement of the seat pads causes each seat pad to fall back in a normal seating position when it is advertently raised by the standing movement of the cyclist. The preferred seat 20 is thereby always in place when a cyclist resumes a sitting position.

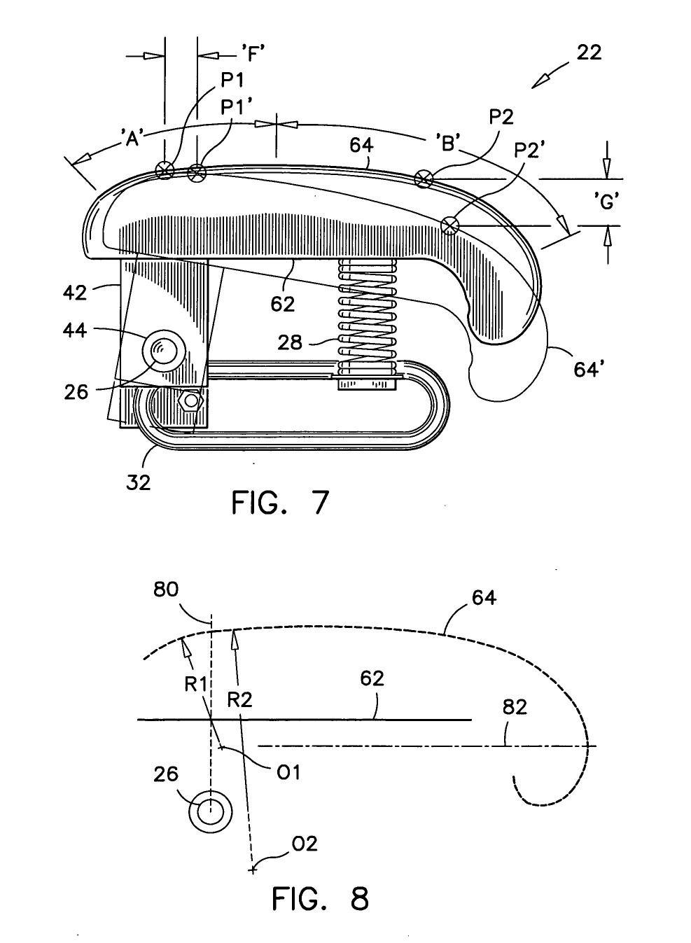

Referring now to FIGS. 7 and 8, other features of the preferred seat 20 will be explained. In particular, the radii of curvature R1 and R2 of the longitudinal circular curvature of region ‘A’ have origins O1 and O2 respectively. These origins O1 and O2 are located on the forward side of pivot axis 26 and of a vertical line 80 drawn to the pivot axis 26. The principal axis 82 of the parabolic curvature in region ‘B’ is located above and forward of the pivot axis 26. The entire parabolic curvature in region ‘B’ is located ahead of the pivot axis 26. Origin points O1 and O2 are located below the principal axis 82 of the parabolic curvature in region ‘B’.

Because of the physical characteristics described above, a displacement ‘F’ between a point P1 and P1′ on a mid-point of the posterior support region ‘A’, in a rotation of the seat pad 22 of about 10° as shown in the shadowed position 64′, is larger in a cosine value or is said to be cosine-dominant. Coincidentally, a displacement ‘G’ between points P2 and P2′ on a mid-point of the thigh support region ‘B’ in a same angular movement of the seat pad 22 is larger in the sine value, or is said to be sine-dominant. In fact the vertical displacement between P2 and P2′ is about 13 times larger that the vertical displacement between P1 and P1′.

As a result, the movement of the seat pad 22 in the posterior support region ‘A’ is almost imperceptible, while the movement under the thigh supporting region ‘B’ is relatively large to allow the thigh muscles to tighten and swell under the effort of pedalling. During a forward inclination of the seat pad 22, as illustrated, no part of the seat pad raises to create a pressure point against the thighs or posterior of the user.

Because of the large radius of rotation ‘C’ of the seat pad 22, the top surface 64 of the seat moves ahead as it tilts forward, as indicated by displacement ‘F’. This displacement is advantageous for pushing the hip and thighbone of the user against the pedal being worked at that time.

In another aspect, the downward movement ‘G’ of the thigh supporting region ‘B’ is about 30% larger than the forward displacement ‘F’. The relative displacements ‘F’ and ‘G’ have been found to be very comfortable for pedalling a bicycle without creating any pressure point on the seat.

What is claimed is:

1. A twin-pad bicycle seat comprising a pair of seat pads and a pivot axis; said seat pads being independently movably mounted side by side on said pivot axis; each of said seat pads having;
a forward end;
a posterior support region above said pivot axis; said posterior support region having a longitudinal circular curvature with radii of curvature having origins located ahead of said pivot axis;
a thigh support region located ahead of said posterior support region and said pivot axis; said thigh support region being contiguous with said posterior support region and having a longitudinal parabolic curvature with a principal axis extending above said pivot axis.

2. The twin-pad bicycle seat as claimed in claim 1, where said origins of said radii are located below said principal axis of said parabolic curvature.

3. The twin-pad bicycle seat as claimed in claim 1, wherein each of said seat pads has a base plate and a length forward of said pivot axis, and said pivot axis is located at a distance below said base plate of at least 25% of said length.

4. The twin-pad bicycle seat as claimed in claim 3, wherein each of said base plates has a spring attached thereto supporting a front portion thereof.

5. The twin-pad bicycle seat as claimed in claim 4, wherein said spring is located at a distance forward from said pivot axis which is at least twice as much as said distance of said pivot axis below said base plate.

6. The twin-pad bicycle seat as claimed in claim 5, wherein said pivot axis is located below said base plate at a distance of at least 1.8 inches.

7. The twin-pad bicycle seat as claimed in claim 1, wherein each of said seat pads has an inside forward corner and a chamfer on said inside forward corner.

8. The twin-pad bicycle seat as claimed in claim 1, wherein each of said pads has a support bracket affixed thereto and said support bracket is pivotally mounted to said pivot axis.

9. The twin-pad bicycle seat as claimed in claim 8, wherein said support bracket has a top transverse segment that is inclined downward toward a centre thereof.

10. The twin-pad bicycle seat as claimed in claim 9, wherein each of said seat pads has a width and a downward inclination toward said other seat pad of ¼ inch over said width.

11. A twin-pad bicycle seat comprising a pair of seat pads and a pivot axis; said seat pads being independently movably mounted side by side on said pivot axis; said pivot axis being mounted to a pair of seat mounting loops;
each of said seat pads having a support bracket affixed thereto and said support bracket being pivotally mounted to said pivot axis;
said support bracket having a bolt extending through a portion thereof and said bolt being mounted to interfere with a portion of one of said mounting loops for restraining a backward tilting of said seat pad about said pivot axis.

12. The twin-pad bicycle seat as claimed in claim 11, wherein said support bracket has a top transverse segment that is inclined transversely downward toward a centre thereof.

13. The twin-pad bicycle seat as claimed in claim 11, wherein each of said seat pads has a width and a downward inclination toward said other seat pad of ¼ inch over said width.

14. The twin-pad bicycle seat as claimed in claim 11, wherein each of said seat pads has;
a forward end;
a posterior support region above said pivot axis; said posterior support region having a longitudinal circular curvature with radii of curvature having origins located ahead of said pivot axis;
a thigh support region located ahead of said posterior support region and said pivot axis; said thigh support region being contiguous with said posterior support region and having a longitudinal parabolic curvature with a principal axis extending above said pivot axis.

15. A twin-pad bicycle seat comprising a pair of seat pads and a pivot axis; said seat pads being independently movably mounted side by side on said pivot axis; each of said seat pads having;
a forward end;
a posterior support region above said pivot axis; said posterior support region having a longitudinal circular curvature with radii of curvature having origins located ahead of said pivot axis;
a thigh support region located ahead of said posterior support region and said pivot axis; said thigh support region being contiguous with said posterior support region, and having a longitudinal parabolic curvature with a principal axis extending above said pivot axis;
said pivot axis being mounted to a pair of seat mounting loops and each of said seat pads having a support bracket affixed thereto and said support bracket being pivotally mounted to said pivot axis;
said support bracket having a bolt extending through a portion thereof and said bolt being mounted to interfere with portion of one of said seat mounting loops for restraining a backward tilting of said seat pad about said pivot axis;
each of said seat pads also having an inside forward corner and a chamfer on said inside forward corner.

16. The twin-pad bicycle seat as claimed in claim 15, wherein said origins of said radii being located below said principal axis of said parabolic curvature.

17. The twin-pad bicycle seat as claimed in claim 15, wherein each said seat pad has a base plate and a length forward of said pivot axis, and said pivot axis is located at a distance below said base plate of at least 25% of said length.

18. The twin-pad bicycle seat as claimed in claim 15, wherein each of said seat pads has a spring attached thereto supporting a front portion thereof.

19. The twin-pad bicycle seat as claimed in claim 15, wherein each of said support brackets has a top transverse segment that is inclined transversely downward toward a centre thereof.

20. The twin-pad bicycle seat as claimed in claim 19, wherein each of said seat pads has a width and a downward inclination toward said other seat pad of ¼ inch over said width.
